(19) United States
(12) Patent Application Publication
(10) Pub. No.: US 2025/0111758 A1
(43) Pub. Date: Apr. 3, 2025

(54) ELECTRONIC CASH REGISTER, DATA CARRIER, AND METHOD FOR COLLECTING DATA FROM A RECEIPT PRODUCED BY AN ELECTRONIC CASH REGISTER AT A POINT OF SALE

(71) Applicants: Adel Maganova, Milano (IT); Ravil Maganov, Dubai (AE); Vildan Khusainov, Verona (IT)

(72) Inventors: Adel Maganova, Milano (IT); Ravil Maganov, Dubai (AE); Vildan Khusainov, Verona (IT)

(21) Appl. No.: 18/375,667

(22) Filed: Oct. 2, 2023

(51) Int. Cl. G07G 1/00; G06Q 20/20

(52) U.S. Cl. CPC G07G 1/0009; G06Q 20/209

(57) ABSTRACT

A method for collecting data from a receipt produced by an electronic cash register at a point of sale, comprising the steps of authorizing, via the electronic cash register, a payment from a customer; generating, via the electronic cash register, a receipt for the payment; preparing, via a print service, a print job file for a printer and sends said print job file to a printer driver; executing, via an electronic cash register utility module in the electronic cash register, to read the print job file; interpreting, via the electronic cash register utility module, the content of the print job file and extracting receipt data; and sending, via the electronic cash register utility module, said receipt data to a remote server.

### TECHNICAL FIELD

The present invention concerns the field of electronic cash register and collection of receipts produced by electronic cash receipts at point of sales.

### BACKGROUND

An Electronic Cash Register serves as a crucial tool in the retail and hospitality industries, primarily at points of sale, with the primary purpose of facilitating efficient and accurate financial transactions. It acts as a central hub for processing sales and handling payments, ensuring that businesses can manage their revenue and inventory effectively.

The central function of an ECR is to record and calculate sales transactions. When a customer makes a purchase, the ECR records the item's price, calculates taxes, and generates a cash receipt as evidence of the transaction. A cash receipt is usually a printed document that provides a detailed summary of the purchase, including the items bought, their prices, any applicable taxes, the total amount paid, payment method, and change given. It serves as proof of purchase for both the customer and the merchant and is essential for accounting, tax reporting, and customer service purposes.

Typical hardware components of an ECR include a cash drawer to store currency and coins, a keyboard or touch screen for inputting transaction data, a barcode scanner for quick item entry, a receipt printer to produce cash receipts, and various connectivity options such as USB or Ethernet for linking to external systems or devices. Additionally, modern ECRs may integrate credit card readers or contactless payment terminals to accommodate a variety of payment methods.

On the software side, an ECR typically runs an electronic cash register software that manages inventory, calculates taxes, tracks sales data, and generates cash receipts. This software may also include features like sales reporting, employee management, and customer relationship management. The software is crucial in automating and streamlining retail operations, enhancing efficiency, and reducing the risk of human errors in transaction processing. The electronic cash register software is often an application software run on an operating system such as Windows®, Android®, Unix® etc.

A printer driver of the operating system is used for printing cash receipts. It is a software component that enables communication between the ECR's software and the receipt printer hardware. The driver interprets the data from the ECR software, formats it appropriately, and sends it to the printer for physical output. It ensures that the cash receipts are printed accurately, with legible text, graphics, and any necessary barcodes. The printer driver is essential for maintaining the integrity of the transaction record and ensuring that customers receive clear and professional-looking receipts.

It is often desired to collect digital cash receipts. Businesses often want to store and process digital cash receipts for record keeping, tax compliance, inventory management, analytics, integration with accounting software, and so on. Customers want to keep record of their purchases for personal record, warranty, returning and exchanging products, loyalty programs and convenience.

While many ECR software solution offer some options for transmitting and processing digital cash receipts, those solutions are usually not compatible among each other's. Different vendors use different Electronic Cash Register software and produce different type of cash receipts with different formats and information. The lack of compatibility among various Electronic Cash Registers software applications pose challenges when it comes to collecting and managing digital cash receipts. There are several reasons for this:
1. Proprietary Systems: Many ECR manufacturers develop proprietary systems and software that are designed to work exclusively with their hardware. This approach creates vendor lock-in, making it difficult for businesses to switch to different ECR solutions without significant effort and cost. As a result, each ECR manufacturer may use a unique software architecture, data format, or communication protocol, leading to incompatibility with other systems and difficulties in transmitting and processing digital receipts from different systems.
2. Diverse Features and Customizations: Different ECRs software applications offer various features and customizations tailored to specific industries and business needs. While this diversity can be beneficial, it also means that each system may have its own unique data structures, database schemas, and configurations, making it challenging to integrate and standardize digital receipt data across different platforms.
3. Data Security and Compliance: Businesses often deal with sensitive financial information and customer data. To ensure data security and compliance with regulatory requirements, ECR software vendors may implement encryption and access control mechanisms that are specific to their systems. These security measures can hinder the seamless sharing of data between different systems.
4. Interoperability Challenges: Interoperability, the ability of different systems to communicate and work together effectively, can be a significant hurdle. Without standardized data exchange formats or industry-wide protocols, integrating data from various ECRs software applications can be complex and costly, requiring custom development and middleware solutions.
5. Vendor Fragmentation: The ECR software market is highly fragmented, with numerous vendors offering a wide range of solutions. This fragmentation can result in a lack of standardization and interoperability efforts across the industry. Businesses may find it challenging to select ECRs and POS software that seamlessly integrate with each other due to this diversity.
6. Legacy Systems: Many businesses still use older ECRs and POS systems that were not designed with modern data interoperability in mind. These legacy systems may lack the necessary connectivity options and data export capabilities, making it even more difficult to collect and manage digital cash receipts.

These factors collectively contribute to the difficulties businesses face when attempting to collect and manage digital cash receipts from a variety of sources.

### BRIEF SUMMARY OF THE INVENTION

An aim of the present invention is the provision of method for generating and collecting data from cash receipts from different type of ECR devices and software.

Another aim is to provide a new technical solution for collecting data from cash receipts from different types of ECRs devices, including incompatible ECRs.

According to the invention, these aims are attained by the object of the attached claims, and especially by a method for collecting data from a receipt produced by an electronic cash register at a point of sale, comprising the steps of:
the electronic cash register authorizes a payment;
the electronic cash register generates a receipt for the payment;
a print service prepares a job file for a printer and sends the job file to a printer driver;
the printer driver sends the job file or a modified job file to a printer;
an electronic cash register utility module executed in the electronic cash register reads the job file;
the electronic cash register utility module interprets the content of the job file and extract receipt data;
the electronic cash register utility module sends the receipt data to a remote server.

The ECR software generates a receipt and sends it in a job to a print service with an indication of the printer on which the receipt will be printed. The print service writes the incoming print job to a file in the working directory. This file is available for a short time until the printer finishes printing. The print service sends a job to a printer driver, which communicates with the connected printer and prints a paper receipt. The notification of successful printing is sent in reverse order from the printer to the printer driver, then to the print service. Temporary print job files are then deleted.

With respect to what is known in the art, the invention provides the advantage that the data corresponding to the cash receipt is collected from a job file that virtually any ECR software generates anyway. The method thus provides a new method of interfacing with virtually any electronic cash register that can print receipt over a print job file. The method can thus be easily deployed with an existing parc of different electronic cash register, without any need for replacing or updating any existing component of existing electronic cash register, and without any need for modifying existing programs.

The method thus relies on the interception and interpretation of print job files for retrieving the receipt data.

### BRIEF DESCRIPTION OF THE DRAWINGS

Exemplar embodiments of the invention are disclosed in the description and illustrated by the drawings in which:

FIG. 1 illustrates schematically an electronic cash register.

FIG. 2 is a workflow illustrating printing of a receipt in an Electronic Cash Register.

FIG. 3 is a workflow illustrating how data from the cash receipt is transmitted to a remote server

FIG. 4 is a workflow illustrating the creation of a wallet pass.

FIG. 5 is a flowchart illustrating reception of a receipt and associated wallet pass by the remote server, wherein the wallet pass data is transmitted by an ECR utility module.

FIG. 6 is a flowchart illustrating reception of a receipt and associated wallet pass by the remote server, wherein the wallet pass data is transmitted with a registration app provided to the merchant.

FIG. 7 is a flowchart illustrating a method for providing an electronic copy of receipt data to the customer.

FIG. 8 is a flowchart illustrating how an ECR utility module is used to print additional customizable information on a cash receipt.

FIG. 9 is a flowchart illustrating how an ECR utility module is used to transmit additional customizable information to a customer over his wallet pass.

### DETAILED DESCRIPTION AND EXAMPLES OF EMBODIMENTS OF THE PRESENT INVENTION

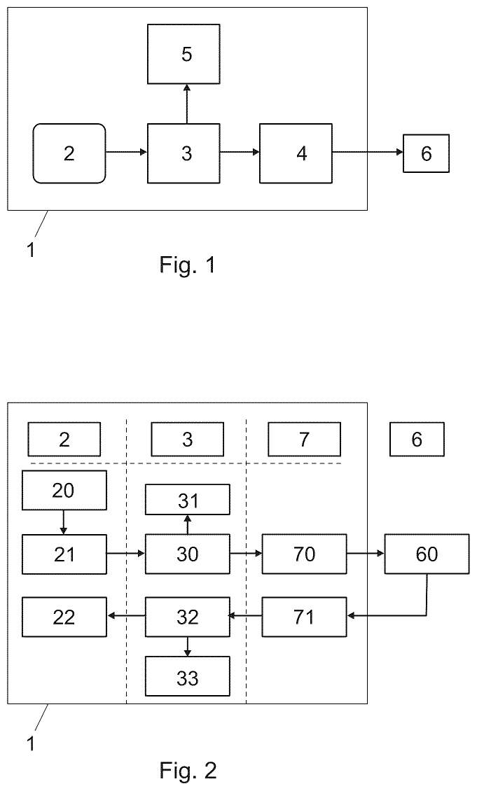

An electronic cash register 1 is shown in FIG. 1. On the software side, it comprises an electronic cash register software 2, a print service 3, and a printer driver 4. All those components may be conventional and executed over a conventional operating system, such as Windows®, Unix® etc. The electronic cash register further includes an interface for a printer (internal or external) and an interface for connecting it to a remote server, for example over a LAN, WLAN, or Internet.

The ECR software may be installed by the supplier or vendor of the ECR, or by the merchant. It accounts for the sale of goods to customer, by preparing a list of goods purchased, calculating the total amount, calculating the taxes, authorizing payment, and generating a print job file so that a paper receipt can be printed by a receipt printer 6 and delivered to the customer. The ECR software typically performs other tasks, such as scanning barcodes, managing inventory, etc.

On the hardware side, the ECR 1 can comprise a computer, for example a generic purpose computer or a dedicated computing system, a keyboard, a display, a barcode scanner, an interface for the printer 6, a cash drawer to store currency and coins, and various connectivity options such as USB or Ethernet for linking to external systems or devices. Additionally, the ECR may integrate credit card readers or contactless payment terminals to accommodate a variety of payment methods.

The print service 3 comprises a set of software components configured to generate print jobs submitted by the ECR software 2. The functionality of the print service may include the reception of requests from the ECR software 2 or from the operating system, the interpretation of print job parameters, the selection of an appropriate printer driver, the generation and storage of a print job file, the transmission of the print job file to a printer driver 4, and the monitoring of print job progress. The print service may be embodied as a standalone application or integrated into the operating system of the ECR 1.

The printer driver 4 is another software component designed to facilitate the communication between the ECR 1 and the printer 6 for the purpose of printing cash receipts. The printer driver can generate a set of instructions and data structures configured to translate the print job file received from the print service 3 into a language understood by the specific make and model of the printer 6. The printer driver may include a library of device-specific settings and configurations, allowing for precise control over print quality, paper handling, and other print job attributes.

A print job is a digital representation of a receipt content that has been submitted for printing through the ECR software 2. The print job encompasses a collection of data and instructions that specify the content to be printed, the desired print settings, and the target printer 6. The data may include text, images, vector graphics, or a combination thereof, formatted in accordance with industry-standard or application-specific page description languages. The print job also contains metadata such as print job name, priority, and user identification. Upon submission by a print service 3, the print job is processed by the associated printer driver 4 and subsequently transmitted to the designated printer 6 for physical output.

The software components so far may be conventional and do not require any modification to carry out the method of the invention. The method can this be carried out with existing, conventional ECR and ECR software.

The ECR 1 of the invention includes a new module 5, referred to as Electronic Cash register Utility module. The ECRU module is an additional software module, for example a software application, installed in the operating system of the ECR and cooperating with the existing ECR software 2 to extend its functionalities. The ECRU module 5 may use standard features of Windows®, Android®, or Linux® OS, and its installation or use does not require any changes to the merchant's ECR software. It may be transmitted to the merchant by email, downloaded from a platform or web site, or on a data carrier, and installed by the merchant in an existing, conventional ECR.

FIG. 2 is a workflow illustrating printing of a receipt using the functionalities of the Electronic Cash Register. At step 20, an operator of the ECR creates an order in the ECR software 2 with a list of purchased products, possibly by scanning barcodes on those products.

At step 21, if the payment from the customer is accepted, the ECR software registers the sale, generates a receipt for the order and sends it to the print service 3 of the operating system. The order may include a list of purchased products, an amount, taxes, the payment method, loyalty programs, possibly an identification of the customer or of its payment card, a date, and/or other data. None of those pieces of data is essential for the invention.

At step 30, the print service 3 generates a print job corresponding to this receipt. The print job is stored as a temporary file at step 31, and send to or read by the printer driver 4.

At step 70, the printer driver translates the print job file received from the print service 3 into a series of commands understood by the printer 6, and send those commands to the printer 6. The printer prints the receipt at step 60, and the customer can take the receipt.

At step 71, upon completion of the print job task, the printer driver 4 is informed by the printer 6. The information is transmitted to the print service 3 which marks the print job as complete during step 32, and deletes the temporary print job file at step 33. The completion of the print job is also transmitted to the ECR software at step 22.

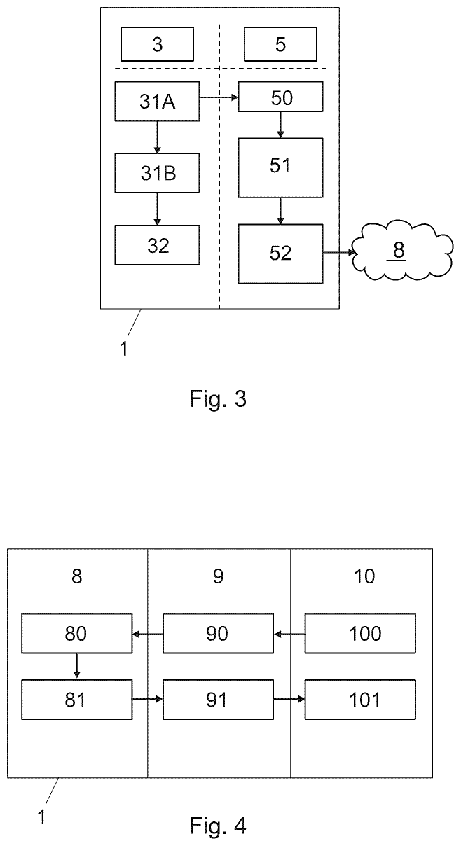

FIG. 3 is a workflow illustrating how data from the cash receipt is transmitted to the ECR utility module 5 and then to a remote server 8 in the cloud or at a remote location. At step 31A, the print service 3 generates a temporary print job file corresponding to the receipt received from the ECR software 2. At step 31B, this print job is sent to or read by the printer driver. Steps 31A and 32B together correspond to previously described step 31. At step 32, upon completion of the print job, the job is marked as complete, and the temporary job file is deleted.

When a task file appears in a Print Service directory of the operating system, the ECR utility module 5 of the invention reads the print job file at step 50. At step 51, this module 5 interprets the content of the print job file and extracts relevant data. The purpose of interpretation is to obtain the original data sent to print in text form and decompose it into relevant fields. The extracted data may include information about sold product items, as well as the total amount of the receipt, total discount, payment method and transaction ID. None of those pieces of data is essential for the invention.

This interpretation/extraction may thus include extracting relevant data fields form the job file, directly if the job file stores this data as alphanumeric character, and/or using optical character recognition if some data fields are stored as images or image vectors. The interpretation may be dependent on the specification of the printer driver manufacturer. The interpretation may use a priori knowledge of the format of the cash receipt; this a prior knowledge may be dependent on the ECR software. Alternatively, or in addition, artificial intelligence modules may be used for interpreting the job file, and classifying the pieces of information in relevant fields.

The data extracted from the print job file maybe saved as a file in any suitable format, such as without limitation .XML, .CSV, .XLS etc. Alternatively, the data may be transmitted over any suitable data transmission format, such as without limitation soap, etc.

At step 52, the ECR utility module 5 sends the data extracted from the print job file to a remote server 8, for example a single file, or through any suitable data exchange.

The remote server 8 can use the retrieved receipt data for various purposes, such as inventory management, fraud detection, etc.

The receipt data received from the remote server 8 can be provided to the customer. In one embodiment, the data is provided in a customer wallet pass, without requiring any changes to the ECR software.

FIG. 4 is a workflow illustrating the creation of a wallet pass for a customer 10. At step 100, customer 10 signs up for a third party wallet pass, such as Google Wallet®, Apple Wallet®, specifying his contact details such as name or alias, e-mail etc. Registration could occur through an application or web page provided by the operator of the remote server 8.

At step 90, a wallet server, such as a Google Wallet server or an Apple Wallet server, receives the customer details and forwards them in a request to the remote server 8. At step 80, the remote server 8 receives this request from the wallet server, registers the customer and creates a Wallet Pass identifier. This identifier is sent to the wallet server 9 which updates the customer profile; it also becomes available at step 101 to the customer 10 for presentation to the merchant.

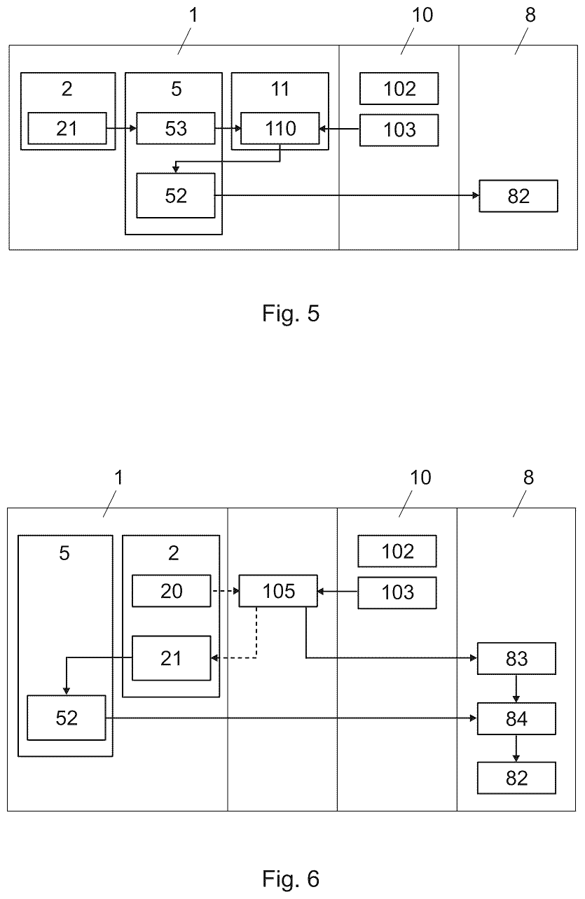

FIG. 5 is a flowchart illustrating reception of a receipt and associated wallet pass by the remote server 8, wherein the wallet pass data is transmitted by the ECR utility module 5. In this embodiment, the wallet pass data is transmitted by the ECR utility module 5. Another embodiment will be described later in relation with FIG. 6 where, at step 104, the wallet pass data is transmitted by a registration app provided to the merchant in order to register a wallet pass presented by customers.

At step 21 of the embodiment of FIG. 5, as previously described, the ECR software generates a receipt corresponding to an order, and send it to a print service which then generates a print job file to be sent to a printer.

At step 53, the ECR utility module 5 extracts and/or interprets receipt data from the print job file, and then displays a message on a display of the ECR 1 with an offer to scan a customer's wallet pass and the input window. At step 103, the customer presents his wallet pass 102, for example as a QR code on his smartphone or smartwatch. At step 110, the ECR utility module scan the wallet pass using a hardware QR code scanner connected to the ECR 1, to retrieve the wallet pass identification.

At step 52, the ECR utility module send the receipt data and the customer's wallet pass identification to the remote server 8, which registers the operation at step 82.

FIG. 6 is a flowchart illustrating reception of a receipt and associated wallet pass by the remote server 8, wherein the wallet pass data is transmitted with a registration app 104 provided to the merchant in order to register a wallet pass presented by customers.

At step 20, as already described, an operator of the ECR creates an order in the ECR software 2 with a list of purchased products, possibly by scanning barcodes on those products.

At step 103, the customer is prompted to present his wallet pass, and present his wallet pass 102, for example by presenting a QR code displayed on his mobile phone to a scanner of the ECR.

At step 105, the operator or the customer scans this customer's wallet pass using a registration app 104 executed in the ECR 1. The registration app then send the scanned wallet pass the remote server 8. At step 83, upon receipt of this wallet app, the remote server 8 waits for receipt data.

At step 21, as previously described, the ECR software 2 generates a receipt for the order and sends it to the print service 3 of the operating system. The order may include a list of purchased products, an amount, taxes, the payment method, loyalty programs, possibly an identification of the customer or of its payment card, a date, and/or other data. None of those pieces of data is essential for the invention. The print receipt may be printed.

At step 52, the ECR utility module 5 extracts and/or interpret receipt data from the print job file. It then send the receipt data to the remote server 8, which links it to the wallet pass at step 84. At step 82, the remote server 8 registers the operation.

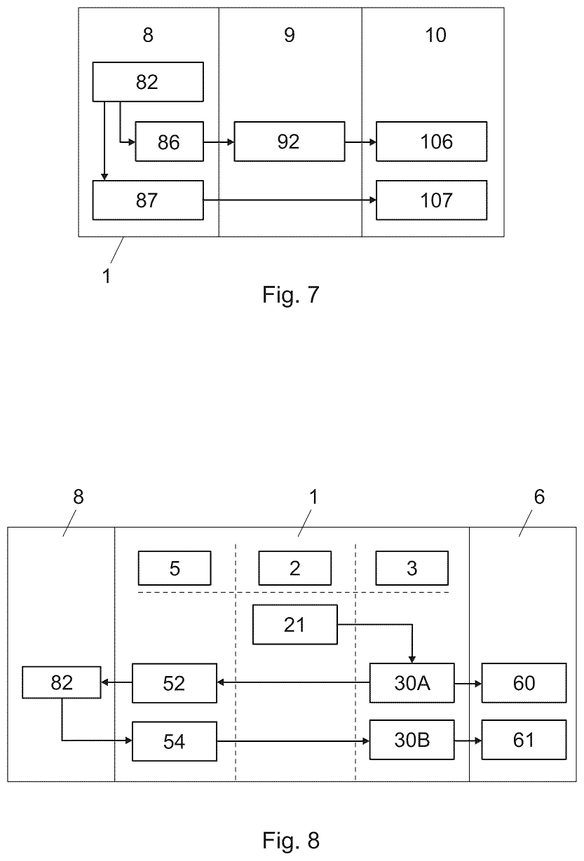

FIG. 7 is a flowchart illustrating a method for providing an electronic copy of receipt data to the customer 10. It involves a remote server 8, a wallet server 9 and the customer 10.

At step 82, as previously explained, the remote server 8 registers an operation with receipt data and an associated wallet pass. At step 86, the server 8 then notifies the customer 10, for example by requesting the wallet server 9 to send a push notification 92 to the customer. The customer is notified at step 106.

At step 87, the remote server 8 sends receipt data in electronic form to the customer, using his contact details provided when registering as a user in the wallet server. The customer is notified at step 107

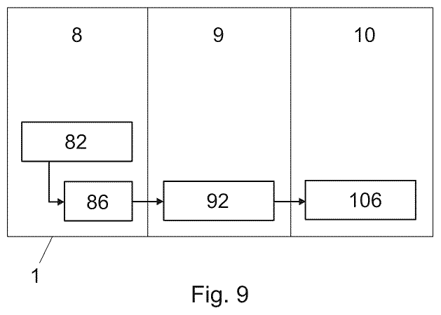

FIG. 8 is a flowchart illustrating how the ECR utility module 5 of the invention may be used to print additional customizable information on a cash receipt, without any changes to the ECR software 2. As will be described later in relation with FIG. 9, the module 5 may also be used for delivering additional information to customers via notifications in their wallet app.

At step 21 of FIG. 8, as previously described, the ECR software 2 generates a receipt for an order and sends it to the print service 3 of the operating system. The order may include a list of purchased products, an amount, taxes, the payment method, loyalty programs, possibly an identification of the customer or of its payment card, a date, and/or other data.

At step 30A, the print service 3 generates a print job corresponding to this receipt. The print job is stored as a temporary print job file, and send to or read by a printer driver, causing the printer 6 to print a cash receipt at step 60.

At step 52, the ECR utility module 5 reads the print job file and extract receipt data from it, as previously described. The receipt data is sent to the remote server 8 which registers the transaction at step 82, and transmit additional information to the ECR utility module 5. The additional information may be customized by the merchant. It may relate to customer information or merchant information or purchased product information available at the remote server. For example, promotion details or additional QR codes related to loyalty programs etc may be printed on the cash receipt, without modifying the ECR software.

At step 54, the ECR utility module 5 receives this additional information, an send it to the print service. A step 30B, the print service receives the additional information, and causes the printer 6 to print the additional information on the cash receipt.

FIG. 9 is a flowchart illustrating how additional information may also be delivered to customers through one or a plurality of notifications sent to their pass wallet.

At step 82, as previously described, a remote server 8 registers a transaction with a customer's wallet pass and associated receipt data extracted with one of the above described methods. The remote server 8 may add additional information, as previously explained.

At step 86, the server 8 then notifies the customer 10, for example by requesting the wallet server 9 to send a push notification 92 to the customer. The customer is notified at step 106.

The ECR utility module 5 of the invention may work in the background, as a service, and without disrupting the normal operation of the ECR. In the event of communication failure, it accumulates a data queue and ensures that the data queue is unloaded after communication with the remote server 8 is restored. A transaction log may be generated with a list of all transaction sent of to be send to the remote server. The transaction log is periodically read by the ECR utility module; if pending transactions are still available in the transaction log, the ECR utility module retries to send them to the remote server 8 until there are no pending transactions in the transaction log.

Therefore receipt data can be transmitted to the remote server 8 when the communication is restored, for example when the available bandwidth is sufficient. Transmission of receipt data thus does not affect operation of the ECR and does not reduce the speed of customer service.

### Additional Features and Terminology

As used herein, the term “electronic cash register,” or “ECR”, in addition to having its ordinary meaning, can refer to a device, equipment or system used by operators at the point of sales for selling products or services.

Many other variations than those described herein will be apparent from this disclosure. For example, depending on the embodiment, certain acts, events, or functions of any of the algorithms described herein can be performed in a different sequence, can be added, merged, or left out altogether. Moreover, in certain embodiments, acts or events can be performed concurrently, for instance, through multi-threaded processing, interrupt processing, or multiple processors or processor cores or on other parallel architectures, rather than sequentially. In addition, different tasks or processes can be performed by different machines or computing systems that can function together.

Unless otherwise specified, the various illustrative logical blocks, modules, and algorithm steps described herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Unless otherwise specified, the various illustrative logical blocks and modules described in connection with the embodiments disclosed herein can be implemented or performed by a machine, a microprocessor, a state machine, a digital signal processor, an application specific integrated circuit, a FPGA, or other programmable logic device, discrete gate or transistor logic, discrete hardware components, or any combination thereof designed to perform the functions described herein. A hardware processor can include electrical circuitry or digital logic circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. A computing environment can include any type of computer system, including, but not limited to, a computer system based on a microprocessor, a mainframe computer, a digital signal processor, a portable computing device, a device controller, or a computational engine within an appliance, to name a few.

Unless otherwise specified, the steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or non-volatile. The processor and the storage medium can reside in an ASIC.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements or states. Thus, such conditional language is not generally intended to imply that features, elements or states are in any way required for one or more embodiments or that one or more embodiments necessarily include logic for deciding, with or without author input or prompting, whether these features, elements or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense so that when used, for example, to connect a list of elements, the term “or” means one, some, or all of the elements in the list. Further, the term “each,” as used herein, in addition to having its ordinary meaning, can mean any subset of a set of elements to which the term “each” is applied.

### REFERENCE SYMBOLS IN THE FIGURES

(Hardware and/or Software Modules, Components or Systems Only)

| | |
|---|---|
| 1 | Electronic cash register |
| 2 | Electronic cash register software |
| 3 | Print service |
| 4 | Printer driver |
| 5 | Electronic cash register utility module |
| 6 | Printer |
| 7 | Printer device driver |
| 8 | Remote server |
| 9 | Wallet service server |
| 10 | Customer or customer device |
| 11 | Hardware and/or software QR scanner |
| 102 | Wallet pass |

1. A method for collecting data from a receipt produced by an electronic cash register at a point of sale, comprising the steps of:
authorizing, via the electronic cash register, a payment from a customer;
generating, via the electronic cash register, a receipt for the payment;
preparing, via a print service, a print job file for a printer and sending said print job file to a printer driver;
executing, via an electronic cash register utility module in the electronic cash register, to read the print job file;
interpreting, via the electronic cash register utility module, the content of the print job file and extracting receipt data; and
sending, via the electronic cash register utility module, said receipt data to a remote server.

2. The method of claim 1, further comprising: sending, via the printer driver, the job file or a modified job file to the printer; and
printing, via the printer, a paper receipt.

3. The method of claim 1, further comprising: monitoring periodically, via the electronic cash register utility module, a print service directory to detect new job files.

4. The method of claim 1, further comprising: converting, via the electronic cash register utility module, images in said print job file into text.

5. The method of claim 1, further comprising: extracting, via the electronic cash register utility module, text or numerical data portions from said print job file, and assign them to data fields.

6. The method of claim 1, further comprising the steps of:
scanning a wallet pass of said customer; and
associating said receipt data with said wallet pass.

7. The method of claim 6, wherein said receipt data is associated with said wallet pass by said ECR utility module.

8. The method of claim 6, wherein said receipt data is associated with said wallet pass by said remote server.

9. An electronic cash register comprising:
a processor;
an interface for a printer;
an electronic cash register software arranged for authorizing payments and for generating receipts for such payments; and
a computer program arranged for carrying out the method of one of the previous claims when said program is executed by said processor.
